(19) United States
(12) Patent Application Publication
(10) Pub. No.: US 2025/0093567 A1
(43) Pub. Date: Mar. 20, 2025

(54) Waveguide Display Having Gratings with Continuous Phase Shifting

(71) Applicant: Apple Inc., Cupertino, CA (US)

(72) Inventors: Brandon Born, Sunnyvale, CA (US); Wencong Zhu, Foster City, CA (US); Jong Young Hong, Boulder, CO (US); Se Baek Oh, Hillsborough, CA (US)

(21) Appl. No.: 18/805,955

(22) Filed: Aug. 15, 2024

Related U.S. Application Data
(60) Provisional application No. 63/583,085, filed on Sep. 15, 2023.

(51) Int. Cl. F21V 8/00; G02B 27/01

(52) U.S. Cl. CPC G02B 6/0016; G02B 6/0036; G02B 27/0172

(57) ABSTRACT

A display may include a waveguide that directs image light to an eye box. The waveguide may include an optical coupler that redirects and replicates the light. The coupler may include a surface relief grating (SRG). The SRG may have a pitch that varies continuously along an axis orthogonal its ridges. The pitch may vary sinusoidally, linearly, parabolically, or according to other continuous and differentiable functions of position along the axis. The SRG may diffract the light. Upon diffracting the light, the SRG may impart a phase to the light. The phase may vary continuously as a function of position along a first axis and may, if desired, vary continuously as a function of position along a second axis orthogonal to the first axis. The SRG may prevent formation of coherent light paths after replication, thereby maximizing the efficiency of the system.

This application claims the benefit of U.S. Provisional Patent Application No. 63/583,085, filed Sep. 15, 2023, which is hereby incorporated by reference herein in its entirety.

### BACKGROUND

This disclosure relates to optical systems such as optical systems in electronic devices having displays.

Electronic devices can include displays that provide images near the eyes of a user. Such electronic devices often include virtual or augmented reality headsets with displays having optical elements that allow users to view the displays. If care is not taken, components used to display images can be bulky and might not exhibit desired levels of optical performance. For example, coherent light paths in the display can produce destructive interference that reduces the efficiency of the display.

### SUMMARY

An electronic device may include a display having a waveguide that directs image light to an eye box. The waveguide may include an optical coupler that redirects and replicates the image light. The optical coupler may include one or more surface relief gratings (SRGs). The SRG may have a pitch that varies continuously along an axis orthogonal to the ridges of the SRG. The pitch may vary sinusoidally, linearly, parabolically, or according to other continuous and differentiable functions of position along the axis.

The SRG may diffract the image light. Upon diffracting the image light, the SRG may impart a phase to the image light. The phase may vary continuously as a function of position along a first axis and may, if desired, vary continuously as a function of position along a second axis orthogonal to the first axis. The SRG may, for example, exhibit a parabolic or paraboloid phase map. If desired, the ridges and troughs of the SRG may follow sinusoidal paths. The SRG may prevent formation of coherent light paths after replication, thereby maximizing the efficiency of the system. Continuously varying the pitch or phase may prevent the formation of smear artifacts in the image light associated with sharp boundaries between regions of different pitch or phase.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with optical couplers in accordance with some embodiments.

FIGS. 3A-3C are top views of illustrative waveguides provided with a surface relief grating in accordance with some embodiments.

FIG. 4 is a front view of an illustrative waveguide having optical couplers formed from surface relief gratings in accordance with some embodiments.

FIG. 5 is a front view of an illustrative waveguide having an optical coupler with first and second overlapping surface relief gratings oriented in different directions in accordance with some embodiments.

FIG. 6 is a front view showing how a surface relief grating having constant pitch can produce coherent light paths in a pupil replicating optical coupler in accordance with some embodiments.

FIG. 7 is a front view of an illustrative surface relief grating having a continuously varied pitch across its lateral area in accordance with some embodiments.

FIG. 8 is a front view of an illustrative surface relief grating having ridges that follow periodic paths in accordance with some embodiments.

FIG. 9 is a plot showing how an illustrative surface relief grating may have a pitch that continuously varies in a parabolic pattern across its lateral area in accordance with some embodiments.

FIG. 10 is a one-dimensional phase map showing how an illustrative surface relief grating may impart a phase to diffracted light that varies parabolically along a first axis in accordance with some embodiments.

FIG. 11 is a two-dimensional phase map showing how an illustrative surface relief grating may impart a phase to diffracted light that varies parabolically along a first axis in accordance with some embodiments.

FIG. 12 is a one-dimensional phase map showing how an illustrative surface relief grating may impart a phase to diffracted light that varies parabolically along a second axis in accordance with some embodiments.

FIG. 13 is a two-dimensional phase map showing how an illustrative surface relief grating may impart a phase to diffracted light that varies parabolically along first and second orthogonal axes in accordance with some embodiments.

FIG. 14 is an exploded front view showing how the ridges of an illustrative surface relief grating provided with a phase map of the types shown in FIGS. 10-13 may follow curved paths in accordance with some embodiments.

### DETAILED DESCRIPTION

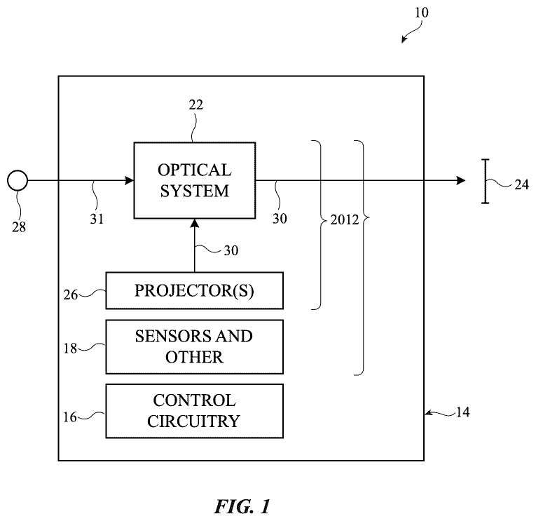

System 10 of FIG. 1 may be a head-mounted device having one or more displays. The displays in system 10 may include near-eye displays 20 mounted within support structure (housing) 14. Support structure 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as support structure 14. Each projector 26 may emit image light 30 that is redirected towards a user's eyes at eye box 24 using an associated one of optical systems 22. Image light 30 may be, for example, light that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner, etc.) to allow real-world light 31 (sometimes referred to herein as world light 31 or ambient light 31) produced and/or reflected from real-world objects 28 (sometimes referred to herein as external objects 28) to be combined optically with virtual (computer-generated) images such as virtual images in image light 30. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of external objects and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

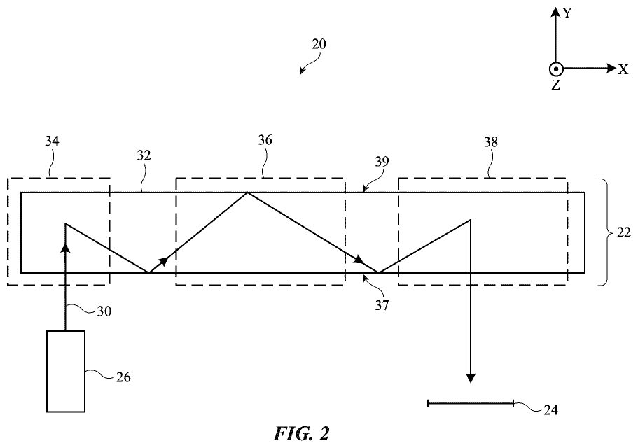

FIG. 2 is a top view of an illustrative display 20 that may be used in system 10 of FIG. 1. As shown in FIG. 2, display 20 may include a projector such as projector 26 and an optical system such as optical system 22. Optical system 22 may include optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc. Waveguide 32 may have a first lateral surface 37 and a second lateral surface 39 opposite lateral surface 37. Lateral surfaces 37 and 39 are sometimes also referred to herein as waveguide surfaces.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer), gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 while optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection. Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), or any other desired input coupling elements.

As an example, projector 26 may emit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is merely illustrative. Optical system 22 may include multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 may include a single optical coupler that performs the operations of both cross-coupler 36 and output coupler 38 (sometimes referred to herein as an interleaved coupler, a diamond coupler, or a diamond expander) or cross-coupler 36 may be separate from output coupler 38. Implementations in which cross-coupler 36 or a single optical coupler that performs the operations of both cross-coupler 36 and output coupler 38 (e.g., which receives light from an input coupler) include surface relief gratings (SRGs) are described herein as an example.

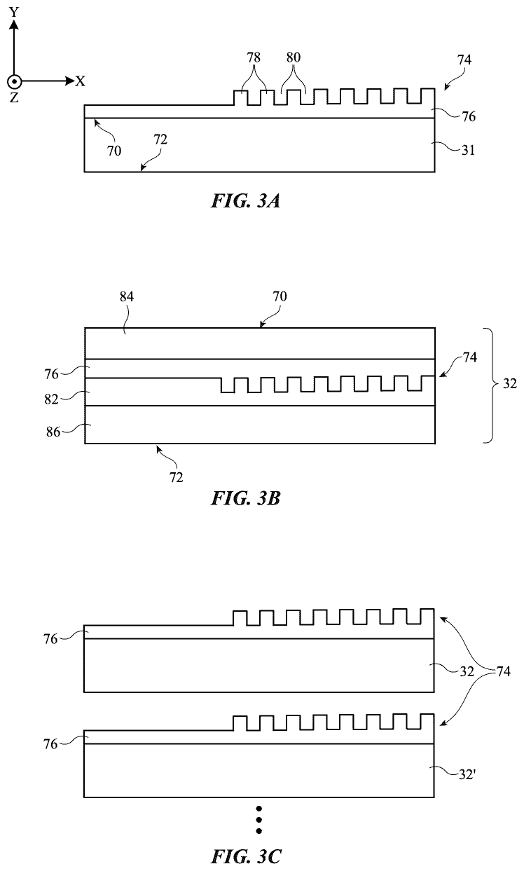

FIG. 3A is a top view showing one example of how a surface relief grating may be formed on waveguide 32. As shown in FIG. 3A, waveguide 32 may have a first lateral surface 70 and a second lateral surface 72 opposite lateral surface 70 (sometimes referred to herein as waveguide surfaces). Waveguide 32 may include any desired number of one or more stacked waveguide substrates. If desired, waveguide 32 may also include a layer of grating medium sandwiched (interposed) between first and second waveguide substrates (e.g., where the first waveguide substrate includes lateral surface 70 and the second waveguide substrate includes lateral surface 72).

Waveguide 32 may be provided with a surface relief grating (SRG) such as surface relief grating 74. SRG 74 may be included in cross-coupler 36 or as part of an optical coupler that performs the operations of both cross-coupler 36 and output coupler 38 (e.g., a diamond expander or interleaved coupler), for example. SRG 74 may be formed within a substrate such as a layer of SRG substrate 76 (sometimes referred to herein as medium 76, medium layer 76, SRG medium 76, or SRG medium layer 76). While only a single SRG 74 is shown in SRG substrate 76 in FIG. 3A for the sake of clarity, SRG substrate 76 may include two or more SRGs 74 (e.g., SRGs having different respective grating vectors). If desired, at least a portion of each of the SRGs may be superimposed in the same volume of SRG substrate 76. In the example of FIG. 3A, SRG substrate 76 is layered onto lateral surface 70 of waveguide 32. This is merely illustrative and, if desired, SRG substrate 76 may be layered onto lateral surface 72 (e.g., the surface of waveguide 32 that faces the eye box).

SRG 74 may include peaks 78 and troughs 80 in the thickness of SRG substrate 76. Peaks 78 may sometimes also be referred to herein as ridges 78 or maxima 78. Troughs 80 may sometimes also be referred to herein as notches 80, slots 80, grooves 80, or minima 80. In the example of FIG. 3A, SRG 74 is illustrated for the sake of clarity as a binary structure in which SRG 74 is defined either by a first thickness associated with ridges 78 or a second thickness associated with troughs 80. This is merely illustrative. If desired, SRG 74 may be non-binary (e.g., may include any desired number of thicknesses following any desired profile, may include ridges 78 that are angled at non-parallel fringe angles with respect to the Y axis, etc.)., may include ridges 78 with surfaces that are tilted (e.g., oriented outside of the X-Z plane), may include troughs 80 that are tilted (e.g., oriented outside of the X-Z plane), may include ridges 78 and/or troughs 80 that have heights and/or depths that follow a modulation envelope, etc. If desired, SRG substrate 76 may be adhered to lateral surface 70 of waveguide 32 using a layer of optically clear adhesive (not shown). SRG 74 may be fabricated separately from waveguide 32 and may be adhered to waveguide 32 after fabrication or may be etched into SRG substrate 76 after SRG substrate 76 has already been layered on waveguide 32, for example.

The example of FIG. 3A is merely illustrative. In another implementation, SRG 74 may be placed at a location within the interior of waveguide 32, as shown in the example of FIG. 3B. As shown in FIG. 3B, waveguide 32 may include a first waveguide substrate 84, a second waveguide substrate 86, and a media layer 82 interposed between waveguide substrate 84 and waveguide substrate 86. Media layer 82 may be a grating or holographic recording medium, a layer of adhesive, a polymer layer, a layer of waveguide substrate, or any other desired layer within waveguide 32. SRG substrate 76 may be layered onto the surface of waveguide substrate 84 that faces waveguide substrate 86. Alternatively, SRG substrate 76 may be layered onto the surface of waveguide substrate 86 that faces waveguide substrate 84.

If desired, multiple SRGs 74 may be distributed across multiple layers of SRG substrate, as shown in the example of FIG. 3C. As shown in FIG. 3C, the optical system may include multiple stacked waveguides such as at least a first waveguide 32 and a second waveguide 32′. A first SRG substrate 76 may be layered onto one of the lateral surfaces of waveguide 32 whereas a second SRG substrate 76′ is layered onto one of the lateral surfaces of waveguide 32′. First SRG substrate 76 may include one or more of the SRGs 74. Second SRG substrate 76′ may include one or more of the SRGs 74. This example is merely illustrative. If desired, the optical system may include more than two stacked waveguides. In examples where the optical system includes more than two waveguides, each waveguide that is provided with an SRG substrate may include one or more SRG 74. While described herein as separate waveguides, waveguides 32 and 32′ of FIG. 3C may also be formed from respective waveguide substrates of the same waveguide, if desired. The arrangements in FIGS. 3A, 3B, and/or 3C may be combined if desired.

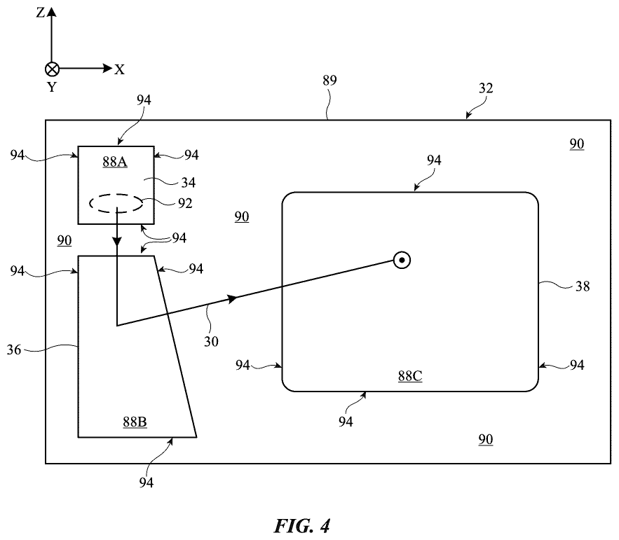

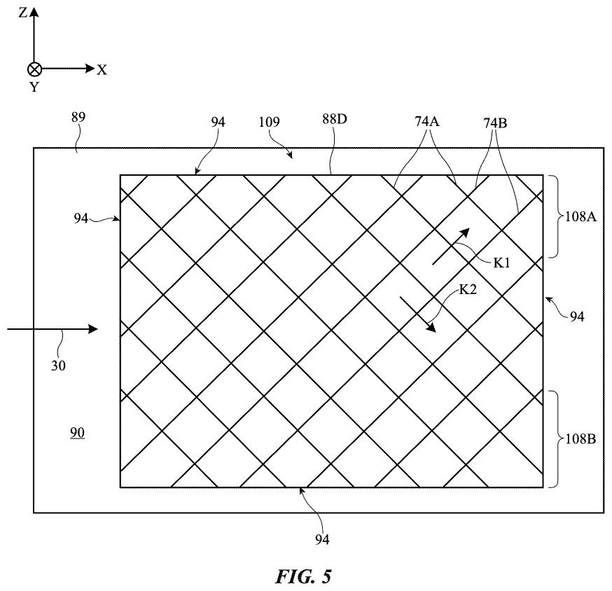

If desired, waveguide 32 may include one or more substrates having regions that include diffractive gratings for input coupler 34, cross-coupler 36, and/or output coupler 38 and having regions that are free from diffractive gratings. FIG. 4 is a front view showing one example of how waveguide 32 may include one or more substrates having regions that include diffractive gratings for input coupler 34, cross-coupler 36, and/or output coupler 38 and having regions that are free from diffractive gratings.

As shown in FIG. 4, waveguide 32 may include one or more substrates 89 (e.g., a single substrate 89 or multiple stacked substrates 89) on one or more waveguides 32 (e.g., a single waveguide 32 or multiple stacked waveguides 32). Substrate(s) 89 may include one or more layers of grating media such as SRG substrate 76 (FIGS. 3A-3B). One or more diffractive grating structures 88 used to form optical couplers for waveguide 32 may be disposed or formed in substrate(s) 89. Each diffractive grating structure 88 may include one or more SRGs 74 (FIGS. 3A-3C).

For example, substrate(s) 89 may include a first diffractive grating structure 88A (sometimes referred to herein as grating structure 88A or grating(s) 88A) formed from a first set of one or more overlapping SRGs 74 (FIGS. 3A-3C) in a first region of substrate(s) 89. If desired, substrate(s) 89 may also include a second diffractive grating structure 88B (sometimes referred to herein as grating structure 88B or grating(s) 88B) formed from a second set of one or more overlapping SRGs 74 in a second region of substrate(s) 89 that is laterally separated from first diffractive grating structure 88A. If desired, substrate(s) 89 may further include a third diffractive grating structure 88C (sometimes referred to herein as grating structure 88C or grating(s) 88C) formed from a third set of one or more overlapping SRGs 74 in a third region of substrate(s) 89 that is laterally separated from first diffractive grating structure 88A and second diffractive grating structure 88B.

Diffractive grating structures 88A, 88B, and 88C may each form respective optical couplers for waveguide 32. For example, diffractive grating structure 88A may form input coupler 34 for waveguide 32. Diffractive grating structure 88B may form cross-coupler (e.g., pupil expander) 36 on waveguide 32. Diffractive grating structure 88C may form output coupler 38 for waveguide 32. Diffractive grating structure 88A may therefore couple a beam 92 of image light 30 into waveguide 32 and towards diffractive grating structure 88B. Diffractive grating structure 88B may redirect image light 30 towards diffractive grating structure 88C and may optionally perform pupil expansion on image light 30 (e.g., may split image light 30 into multiple paths to form a larger beam that covers the eye pupil and forms a more uniform image). Diffractive grating structure 88C may couple image light 30 out of waveguide 32 and towards the eye box. If desired, diffractive grating structure 88C may also perform pupil expansion on image light 30.

Substrate(s) 89 and thus waveguide 32 may also include one or more regions 90 that are free from diffractive grating structures 88, diffractive gratings, or optical couplers. Regions 90 may, for example, be free from ridges 78 and troughs 80 of any SRGs (FIGS. 3A-3C) and may, if desired, be free from refractive index modulations of VPHs. Regions 90 may separate diffractive grating structure 88A from diffractive grating structure 88B, may separate diffractive grating structure 88B from diffractive grating structure 88C, may separate diffractive grating structure 88C from diffractive grating structure 88A, and/or may laterally surround one or all of diffractive grating structures 88A-C. Regions 90 may sometimes be referred to herein as grating-free regions 90, inter-grating regions 90, non-grating regions 90, or non-diffractive regions 90. Non-diffractive regions 90 may, for example, include all of the lateral area of substrate(s) 89 that does not include a diffractive grating.

Each diffractive grating structure 88 in substrate(s) 89 may span a corresponding lateral area of substrate(s) 89. The lateral area spanned by each diffractive grating structure 88 is defined (bounded) by the lateral edge(s) 94 of that diffractive grating structure 88. Lateral edges 94 may separate or divide the portions of substrate(s) 89 that include thickness modulations used to form one or more SRG(s) in diffractive grating structures 88 from the non-diffractive regions 90 on substrate(s) 89. In other words, lateral edges 94 may define the boundaries between diffractive grating structures 88 and non-diffractive regions 90. Diffractive grating structures 88A, 88B, and 88C may have any desired lateral shapes (e.g., as defined by lateral edges 94).

The example of FIG. 4 is merely illustrative and, in general, input coupler 34, cross-coupler 36, and output coupler 38 may have any desired lateral outlines or shapes (e.g., as defined by lateral edges 94). If desired, waveguide 32 may include an optical coupler that both redirects and expands/replicates image light 30 (e.g., for filling as large of an eye box 24 with as uniform-intensity image light 30 as possible). Such an optical coupler, which is sometimes referred to herein as a diamond expander or interleaved coupler, may perform the functionality of both cross coupler 36 and output coupler 38. By using the optical coupler as both a cross-coupler and an output coupler, space may be conserved within the display (e.g., space that would otherwise be occupied by separate cross-coupler and output couplers).

FIG. 5 is a front view of one such optical coupler 109 on waveguide 32. Optical coupler 109 may, for example, replace cross coupler 36 and output coupler 38 on waveguide 32 of FIG. 4. As shown in FIG. 5, optical coupler 109 may include a diffractive grating structure 88D having at least a first SRG 74A and a second SRG 74B on substrate(s) 89 (e.g., superimposed with each other in the same volume of a single substrate 89). Each of SRGs 74A and 74B may include a respective set of ridges 78 and troughs 80 (FIGS. 3A-3C) in substrate 89 and extending in different respective orientations. For example, SRG 74A may be characterized by a first grating vector K1 (e.g., oriented orthogonal to the direction of the peaks, troughs, or lines of constant medium thickness in SRG 74A). Similarly, SRG 74B may be characterized by a second grating vector K2 (e.g., oriented orthogonal to the direction of the peaks, troughs, or lines of constant medium thickness in SRG 74B). Grating vector K2 may be oriented non-parallel with respect to grating vector K1.

The magnitude of grating vector K1 corresponds to the widths and spacings (e.g., the period) of the ridges 78 and troughs 80 (fringes) in SRG 74A, as well as to the wavelengths of light diffracted by the SRG. The magnitude of grating vector K2 corresponds to the widths and spacings (e.g., the period) of the ridges 78 and troughs 80 in SRG 74B, as well as to the wavelengths of light diffracted by the SRG. Surface relief gratings generally have a wide bandwidth. The bandwidth of SRGs 74A and 74B may encompass each of the wavelengths in image light 30, for example (e.g., the entire visible spectrum, a portion of the visible spectrum, portions of the infrared or near-infrared spectrum, some or all of the visible spectrum and a portion of the infrared or near-infrared spectrum, etc.). The magnitude of grating vector K2 may be equal to the magnitude of grating vector K1 or may be different from the magnitude of grating vector K1. While illustrated within the plane of the page of FIG. 5 for the sake of clarity, grating vectors K1 and/or K2 may have non-zero vector components parallel to the Y-axis (e.g., grating vectors K1 and K2 may be tilted into or out of the page).

SRG 74A at least partially overlaps SRG 74B in optical coupler 109 (e.g., at least some of the ridges and troughs of each SRG spatially overlap or are superimposed within the same volume of SRG substrate). If desired, the strength of SRG 74A and/or SRG 74B may be modulated in the vertical direction (e.g., along the Z-axis) and/or in the horizontal direction (e.g., along the X-axis). If desired, one or both of SRGs 74A and 74B may have a magnitude that decreases to zero within peripheral regions 108A and 108B of the field of view, which may help to mitigate the production of rainbow artifacts.

Input coupler 34 (FIG. 2) may couple image light 30 into waveguide 32, which conveys the image light to optical coupler 109 through waveguide 32 (e.g., via total internal reflection). SRGs 74A and 74B may diffract incident image light 30 in two different directions, thereby replicating pupils of the image light. SRGs 74A and 74B may additionally or alternatively expand and/or replicate pupils of the image light. This creates multiple optical paths for image light 30 within optical coupler 89 and allows as large an eye box as possible to be filled with image light 30 of uniform intensity.

SRG 74A and SRG 74B may be formed in the same layer of SRG substrate 76 or may be disposed in separate layers of SRG substrate that are disposed on opposing lateral surfaces of waveguide 32 or substrate 89. In another suitable implementation, waveguide 32 or substrate 89 includes a first layer of SRG substrate on a first lateral surface and a second layer of SRG substrate on a second lateral surface opposite the first lateral surface, where the first layer of SRG substrate include SRGs 74A and 74B and the second layer of SRG substrate includes additional overlapping/crossed SRGs such as SRGs 74A and 74B.

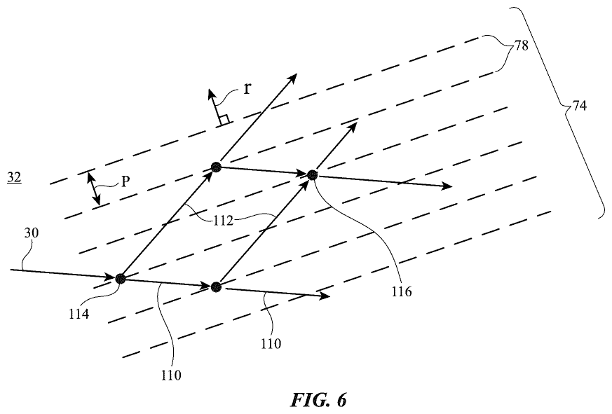

One or more of the SRG(s) on waveguide 32 (e.g., SRGs 74A and 74B of FIG. 5, one or more SRGs in optical couplers 88A, 88B, and/or 88C of FIG. 4, etc.) may perform pupil replication on the image light 30 propagating along waveguide 32. Pupil replication involves the splitting of an incident beam of image light 30 into two different optical paths while propagating along the optical coupler. If care is not taken, pupil replication by the SRG(s) can produce undesirable coherent light paths for image light 30. FIG. 6 is a front view showing an example of how an SRG 74 may perform pupil replication.

As shown in FIG. 6, image light 30 is incident upon SRG 74 in a first direction while propagating along waveguide 32 via TIR. When the image light first hits SRG 74 (e.g., in a first TIR bounce at/off SRG 74 at point 114), SRG 74 diffracts some of the image light in a second direction, as shown by arrow 112, while a remainder of the image light continues to propagate in the first direction (e.g., un-diffracted), as shown by arrow 110. When the un-diffracted light hits the SRG substrate again (e.g., in a second TIR bounce), SRG 74 again diffracts some of the image light in the second direction (e.g., to point 116) while a remainder of the image light continues to propagate in the first direction. At the same time, when the light diffracted in the direction of arrow 112 in the first TIR bounce at point 114 hits the SRG substrate again (e.g., in a second TIR bounce), SRG 74 again diffracts some of the image light in the second direction while a remainder of the image light continues to propagate in the first direction (e.g., to point 116). This replication of light paths may continue across the lateral area of SRG 74 as image light 30 continues to propagate via TIR along waveguide 32 (e.g., producing a large number of replicated pupils of image light 30 to fill as large an eye box as possible with as uniform an amount of image light as possible).

SRG 74 is characterized by a corresponding grating pitch P. Pitch P is defined by the lateral distance/separation between adjacent ridges 78 at a surface of the corresponding SRG substrate. SRG 74 is also characterized by a grating vector oriented in direction r, orthogonal to ridges 78 (e.g., orthogonal to the lines of constant SRG substrate thickness in SRG 74). Spatial position along direction r is sometimes denoted herein as position R.

In some implementations, pitch P is constant across the lateral area of SRG 74. In these implementations, the diffraction of image light 30 by SRG 74 causes image light 30 to follow two optical/light paths of nearly the same path length that are then recombined (e.g., a first path from point 114 to point 116 via an arrow 110 and then an arrow 112 and a second path from point 114 to point 116 via an arrow 112 and then an arrow 110). This effectively creates a network of Mach-Zehnder interferometers across the lateral area of SRG 74. If the phase relationship between the image light following the first path and the image light following the second path is not tightly controlled, phase differences between the first and second paths can produce destructive interference when the light from the first path is recombined with the light from the second path at point 116. The destructive interference can reduce the amount of image light 30 that reaches the eye box, thereby limiting the modulation transfer function (MTF) and/or efficiency of the display. It would therefore be desirable to be able to control the relative phases between the light paths in SRG 74 in a manner that minimizes destructive interference and thus maximizes spatial uniformity and angular image uniformity at the eye box.

To maximize spatial uniformity and angular image uniformity at the eye box, SRG 74 may be configured to cause the first and second path lengths (e.g., from point 114 to point 116) to be different (e.g., across all of the region(s) of the SRG 74 that are used in pupil replication). One way of achieving this is by perturbing (e.g., chirping) the phase of the SRG and thus the phase imparted to the image light diffracted by the SRG over the pupil replication region(s). SRG 74 may, for example, have a pitch P and/or an angle that is spatially varied (chirped) across its lateral area by a small percentage that causes the ridges of the SRG to slip in and out of phase relative to a constant pitch SRG.

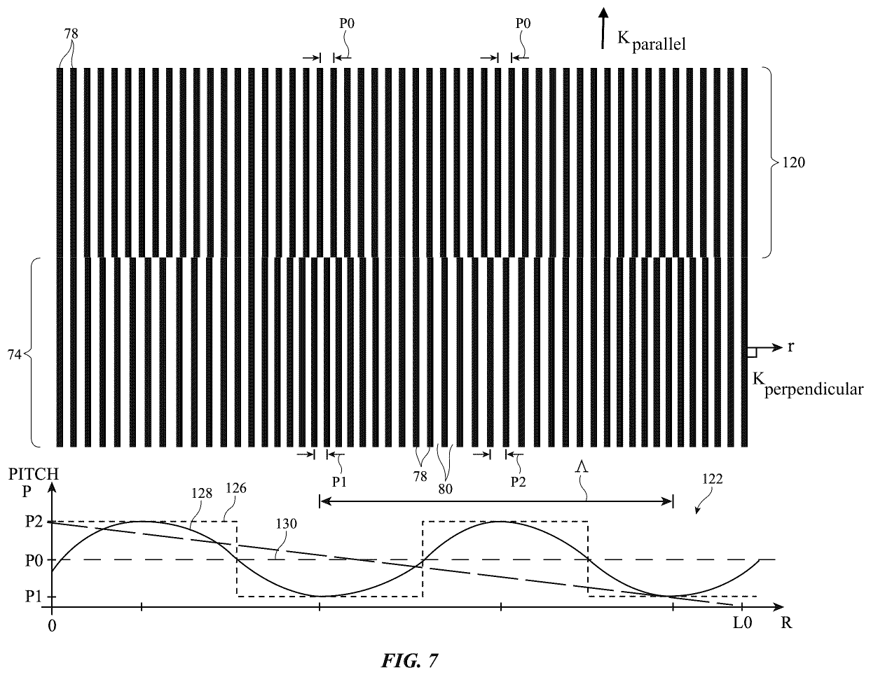

FIG. 7 is a front view showing how an illustrative SRG 74 may be provided with a pitch P that is spatially varied across its lateral area. As shown in FIG. 7, SRG 74 may have ridges 78 and troughs 80 that are characterized by pitch P and that are oriented orthogonal to direction r. SRG 74 has a length L0 in direction r.

As shown by SRG 74, SRG 74 has a variable pitch P that varies from a maximum pitch P2 to a minimum pitch P1 at spatial positions R along direction r. Portion 120 in FIG. 7 illustrate the ridges 78 of an SRG that has a constant pitch P0 at all spatial positions R along direction r from R=0 to R=L0 for the sake of comparison. The parallel ridges in portion 120 are characterized by a first vector Kₚₐᵣₐₗₗₑₗ oriented in the direction of the ridges and a second vector K_{perpendicular} orthogonal to vector Kₚₐᵣₐₗₗₑₗ (e.g., oriented perpendicular to the direction of the ridges). Portion 120 illustrates an example without any modulation in grating angle or pitch (e.g., without any shifting of phase along vector Kₚₐᵣₐₗₗₑₗ or vector K_{perpendicular}). As shown by portion 120 and SRG 74, the ridges 78 in SRG 74 are spatially and periodically chirped (varied) along direction r and in the direction of vector K_{perpendicular}.

Plot 122 of FIG. 7 plots the pitch of SRG 74 at different positions R along direction r (e.g., from R=0 to R=L0). In some implementations, the pitch of SRG 74 is varied discretely (e.g., discontinuously) between regions with pitch P1 and regions with pitch P2, as shown by square waveform 126. However, discretely varying the pitch of SRG 74 can limit the MTF of the SRG and can produce unsightly smear artifacts for pupils of image light 30 that are incident upon the boundaries between the discrete regions with pitch P1 and the discrete regions with pitch P2.

To mitigate these issues, SRG 74 may be provided with a pitch P that varies continuously as a function of position R along direction r and vector K_{perpendicular} (e.g., that varies smoothly without discrete or non-differentiable jumps in pitch P from R=0 to R=L0). In other words, the pitch P of SRG 74 is continuously varied/changed or continuously chirped as a function of spatial position. If desired, the pitch P of SRG 74 may continuously vary in a periodic manner between pitch P1 and pitch P2 as a function of position R. For example, pitch P may vary sinusoidally between pitch P1 and pitch P2 from R=0 to R=L0, as shown by curve 128. Unlike square waveform 126, curve 128 is continuous and differentiable at all points between R=0 and R=L0, thereby mitigating the formation of smear artifacts and maximizing MTF.

Ideally, the percentage by which pitch P is spatially chirped causes the SRG to slip in and out of phase relative to the constant pitch P0 (see portion 120 of FIG. 7) by at most 2π radians (e.g., one pitch deviation). This type of pitch modulation will impart a phase shift to first order diffracted light with respect to light incident at other locations. This modulation is defined by the equation f(x)=P+ΔP(R), where ΔP(R)=(π*P/Λ)*sin(2π*R/Λ) and Λ is the period of the pitch chirping, defined as the distance over which the grating lines (ridges 78) shift cumulative increase by a positive grating period then cumulative decrease by a positive grating period. The average pitch of SRG 74 from R=0 to R=L0 remains the same as the nominal design pitch (e.g., pitch P0).

The example of FIG. 7 illustrates two full sinusoidal pitch chirping periods (Λ) of SRG 74. The sinusoidal variation of pitch P (e.g., as given by curve 128) is depicted in an exaggerated form in the SRG 74 of FIG. 7 to help illustrate the variation. In practice, this 2π phase shift is applied to the SRG over millimeter-scale distances, becoming a subtle perturbation to the spacing of ridges 78 that varies across positions R. Λ should be sufficiently large such that the pitch modulation minimizes smear effects and MTF impact (e.g., 1-20 mm or other values dependent on pupil spacing distance, waveguide thickness, and TIR angle). SRG 74 may exhibit a continuously varied or chirped pitch P only within regions of the SRG 74 that perform pupil replication to minimize impact to MTF.

The example of FIG. 7 is merely illustrative. In general, pitch P may be continuously modulated or varied in any desired manner between R=0 and R=L0. For example, pitch P may be continuously varied between pitch P1 and P2 in a linear manner, as shown by curve 130, in a parabolic manner, in a hyperbolic manner, or according to any desired continuous and differentiable function that varies continuously between pitch P1 and pitch P2 as a function of position R from R=0 to R=L0. The function need not be periodic but may, if desired, be periodic (e.g., sinusoidal). A parabolic variation may, for example, help to improve spatial uniformity while introducing less MTF reduction than other variations.

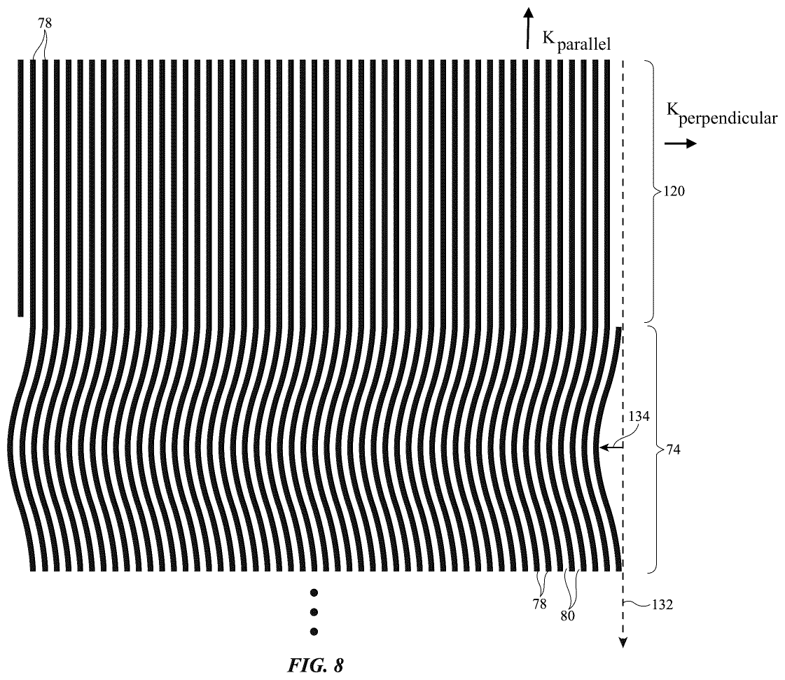

In the example of FIG. 7, the ridges 78 and troughs 80 of SRG 74 are linear and extend in straight lines orthogonal to direction r (vector K_{perpendicular}). Put differently, ridges 78 and thus the SRG 74 of FIG. 7 exhibit a constant angle but a continuously changing/varying (modulated) pitch, changing phase along vector K_{perpendicular}. This is merely illustrative. Additionally or alternatively, ridges 78 and troughs 80 and thus SRG 74 may exhibit a continuously changing/varying (modulated) angle (e.g., may follow non-linear curved paths) to further maximize MTF. FIG. 8 is a front view showing one example of how the ridges 78 and troughs 80 in SRG 74 may exhibit a continuously changing/varying angle but a constant pitch.

Portion 120 of FIG. 8 illustrates ridges 78 that follow linear paths (e.g., parallel to arrow 132) with no modulation in pitch (e.g., no variation in phase along vector K_{perpendicular}) and no modulation in angle (e.g., no variation in phase along vector Kₚₐᵣₐₗₗₑₗ) for the sake of comparison. As shown by SRG 74 of FIG. 8, the position of the ridges 78 and troughs 80 of SRG 74 may vary from lines parallel to arrow 132 by different amounts 134 along the direction of arrow 132 (e.g., may exhibit changing grating angle and thus changing phase along vector Kₚₐᵣₐₗₗₑₗ). Put differently, the ridges 78 and troughs 80 of SRG 74 may follow non-linear paths (e.g., curved paths) such as sinusoidal paths along the direction of arrow 132. The amplitude of SRG 74 may be no greater than the pitch of the SRG. The sinusoidal periodicity of the paths followed by ridges 78 and troughs 80 (e.g., along arrow 132) may be on the order of the millimeter-scale pupil spacing distance. This periodicity may be varied over the lateral area of the grating if desired.

In the example of FIG. 8, SRG 74 is illustrated as having a constant pitch P for the sake of clarity. This is merely illustrative and, if desired, ridges 78 and troughs 80 may follow non-linear (curved) paths (e.g., sinusoidal paths) in addition to having a continuously varied (chirped) pitch across the lateral area of SRG 74 (e.g., using any of the variable pitches described herein such as the sinusoidally variable pitch of FIG. 7, the linearly variable pitch of FIG. 7, a parabolically variable pitch, etc.). Put differently, SRG 74 may have both continuously varied pitch (e.g., changing/modulating phase along vector K_{perpendicular} as shown in FIG. 7) and continuously varied angle (e.g., changing/modulating phase along vector Kₚₐᵣₐₗₗₑₗ as shown in FIG. 8). When combined, the orthogonal components of continuous phase variation in the direction of vectors K_{perpendicular} and Kₚₐᵣₐₗₗₑₗ may produce any arbitrary phase pattern for SRG 74. The below examples show a few illustrative and non-limiting phase patterns of interest for SRG.

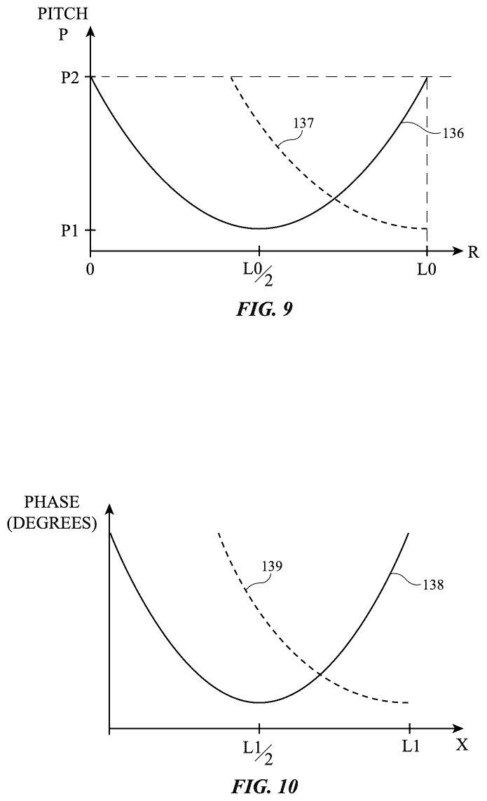

Curve 136 of FIG. 9 shows one example of how the pitch of SRG 74 may be continuously varied in a parabolic pattern (e.g., to improve spatial uniformity while introducing less MTF reduction). As shown by curve 136, the pitch P of SRG 74 may be given by a parabola over positions R, having a minimum equal to pitch P1 and having maxima equal to pitch P2. The minimum of the parabola may be at half the length of SRG 74 (e.g., at R=L0/2). Alternatively, the parabola may be shifted or offset with respect to the spatial center of SRG 74 (e.g., such that the minimum is located at other positions R than R=L0/2), as shown by curve 137. Alternatively, curve 136 or curve 137 may be inverted (e.g., SRG 74 may have maximum pitch P2 at position R=L0/2 and may have minimum pitch P1 at position R=0 and R=L0).

FIG. 10 is a one-dimensional phase map showing how parabolically varying pitch P (as shown in FIG. 9) causes SRG 74 to impart different phase shifts to image light 30 at different positions along a first spatial axis (e.g., axis X). SRG 74 may have a first dimension (e.g., length) L1 along axis X. Curve 138 plots the phase imparted to image light 30 upon diffraction by the SRG at different positions along axis X when the SRG has a pitch P with the parabolic variation of curve 136 in FIG. 9. Curve 139 plots the phase imparted to image light 30 upon diffraction by the SRG at different positions along axis X when the SRG has a pitch P with the parabolic variation of curve 137 in FIG. 9. In other words, the parabolic chirping of phase P across position R in SRG 74 configures SRG 74 to exhibit a corresponding parabolic phase map along axis X (e.g., imparting the diffracted image light 30 with different phases or phase shifts as given by curve 138).

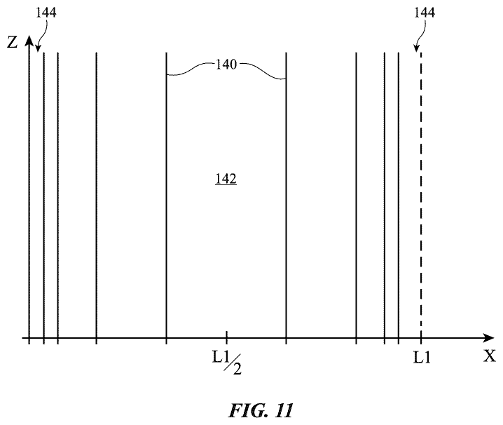

FIG. 11 is a two-dimensional phase map showing how SRG 74 may impart different phase shifts to image light 30 at different spatial positions when SRG 74 has a pitch P that varies parabolically only along a single axis. Lines 140 of FIG. 11 are lines of constant phase imparted to diffracted light at different two-dimensional spatial positions (e.g., within the X-Z plane). Parabolically varying pitch and thus phase along one dimension (e.g., axis X as shown in FIG. 10) causes SRG 74 to exhibit lines of constant phase parallel to the Z-axis, where the phase varies parabolically from a minimum phase within central region 142 to a maximum phase within peripheral regions 144. In this way, the one-dimensional phase profile of FIG. 10 may configure SRG 74 to exhibit a cylindrical two-dimensional phase map (e.g., imparting the image light 30 with a cylindrical phase profile across the X-Z plane). This may, for example, configure the SRG 74 to form a cylindrical lens for the image light.

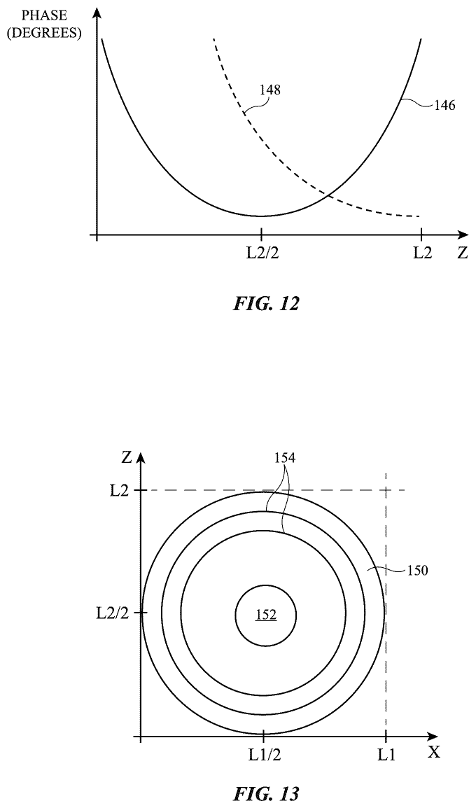

If desired, SRG 74 may exhibit a parabolic phase profile along the Z-axis in addition to along the X-axis (e.g., by also parabolically varying pitch P as shown by curves 136 or 137 of FIG. 9 but along an axis non-parallel to direction r). FIG. 12 is a one-dimensional phase map showing how parabolically varying pitch P (as shown in FIG. 9) along an axis non-parallel to direction r causes SRG 74 to impart different phase shifts to image light 30 at different positions along a second spatial axis orthogonal to axis X (e.g., axis Z). SRG 74 may have a second dimension (e.g., width) L2 along the axis Z.

Curve 146 plots the phase imparted to image light 30 upon diffraction by the SRG at different positions along axis Z when the SRG has a pitch P with a parabolic variation along the axis Z and centered along axis Z (e.g., at L2/2). Curve 148 plots the phase imparted to image light 30 upon diffraction by the SRG at different positions along axis Z when the SRG has a pitch P with the parabolic variation along the axis Z that is offset from the center of width L2. In other words, the parabolic chirping of phase P across an axis orthogonal to direction r in SRG 74 configures SRG 74 to exhibit a corresponding parabolic phase map along axis Z (e.g., imparting the diffracted image light 30 with different phases or phase shifts as given by curve 146). When combined with the parabolic phase map along axis X (e.g., as given by curve 138 of FIG. 10), SRG 74 may exhibit a paraboloid phase profile (map).

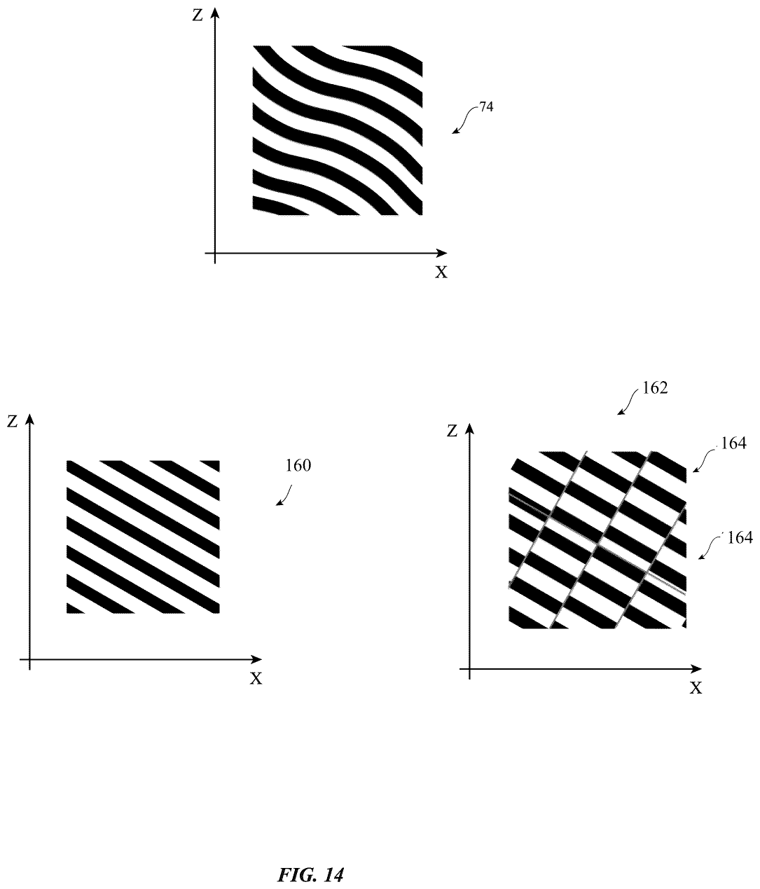

FIG. 13 is a two-dimensional phase map showing how SRG 74 may exhibit a paraboloid phase profile (map). Curves 154 of FIG. 13 are curves of constant phase imparted to diffracted light at different two-dimensional spatial positions (e.g., within the X-Z plane). Parabolically varying the phase along axis X (as shown by curve 138 of FIG. 10) while also parabolically varying the phase along axis Z (as shown by curve 146 of FIG. 10) causes SRG 74 to exhibit circles or ellipses of constant phase around a central region 152 (e.g., at Z=L2/2 and X=L1/2), where the phase varies parabolically from a minimum phase in central region 152 to a maximum phase in peripheral region 150. In this way, SRG 74 may exhibit a paraboloid phase profile (map) across its lateral area (e.g., in the X-Z plane). This may, for example, configure SRG 74 to form a lens (e.g., a parabolic lens) that imparts optical power to image light 30. At the same time, the phase profile may minimize coherent light paths in SRG 74 and/or may maximize MTF. The examples of FIGS. 9-13 are merely illustrative and, in general, SRG 74 may be provided with any continuously varying one or two dimensional phase map (e.g., having lines or curves of constant phase of any desired shape).

FIG. 14 is an exploded view showing how the ridges 78 in SRG 74 may follow different paths when provided with no phase shifting, discrete phase shifting, and continuous phase shifting (e.g., as chirped using any of the pitch and/or angle variations described herein). Portion 160 of FIG. 14 shows the ridges and troughs of an SRG that does not have any phase shifting (e.g., that does not have any variation or modulation in pitch or angle) across its spatial area (e.g., in the X-Z plane). Portion 162 of FIG. 14 shows the ridges and troughs of an SRG that has discrete phase shifting across its spatial area. As shown in portion 162, different discrete regions 164 of the lateral area of the SRG are provided with different discrete grating pitches and/or angles (e.g., a first region 164 has a first pitch and/or angle, a second region 164 adjacent to the first region has a second pitch that is discontinuous with the first pitch and/or a second angle that is discontinuous with the first angle, etc.). The top portion of FIG. 14 shows SRG 74 having continuous phase shifting across its spatial area. As shown by SRG 74 of FIG. 14, the SRG may be provided with a continuously changing pitch and/or a continuously changing angle across its lateral area. This may, for example, serve to prevent the formation of smear artifacts in the image light associated with sharp boundaries between regions of different pitch or phase, while also maximizing spatial uniformity and MTF. One or more of the SRGs described herein may be provided with the any of the chirped pitches, angles, and/or phase profiles (maps) described herein (e.g., SRGs in one or more of the optical couplers described herein). If desired, the SRGs described herein may be replaced with other types of gratings such as metagratings or volume holograms (e.g., where the lines of constant refractive index of the volume holograms replace the lines of constant modulation thickness of the SRGs and are provided with one of the continuously varied pitches and/or one of the phase maps described herein).

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

System 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. An electronic device comprising:
a waveguide configured to propagate light; and
an optical coupler configured to redirect and replicate the light, wherein the optical coupler includes
a substrate on the waveguide, and
a surface relief grating (SRG) in the substrate, wherein the SRG has ridges with a pitch that varies continuously as a function of position along an axis orthogonal to the ridges.

2. The electronic device of claim 1, wherein the pitch varies periodically as a function of position along the axis.

3. The electronic device of claim 2, wherein the pitch varies sinusoidally as a function of position along the axis.

4. The electronic device of claim 3, wherein the ridges follow periodic paths.

5. The electronic device of claim 4, wherein the periodic paths comprise sinusoidal paths.

6. The electronic device of claim 1, wherein the pitch varies parabolically as a function of position along the axis.

7. The electronic device of claim 6, wherein the SRG has a length along the axis and the SRG has a minimum pitch halfway along the length.

8. The electronic device of claim 6, wherein the SRG has a length along the axis and the SRG has a minimum pitch that is offset from halfway along the length.

9. The electronic device of claim 1, further comprising:
an additional SRG in the substrate and overlapping the SRG, wherein the additional SRG has additional ridges oriented non-parallel with respect to the ridges in the SRG, and wherein the additional ridges have an additional pitch that varies continuously as a function of position along an additional axis orthogonal to the additional ridges.

10. The electronic device of claim 1, wherein the waveguide has a first lateral surface, a second lateral surface opposite the first lateral surface, and the substrate is layered on the first lateral surface, the electronic device further comprising:
an additional substrate layered on the second lateral surface; and
an additional SRG in the additional substrate and overlapping the SRG, wherein the additional SRG has additional ridges oriented non-parallel with respect to the ridges in the SRG, and wherein the additional ridges have an additional pitch that varies continuously as a function of position along an additional axis orthogonal to the additional ridges.

11. The electronic device of claim 1, further comprising:
an input coupler configured to couple the light into the waveguide; and
an output coupler configured to couple the light out of the waveguide, the optical coupler comprising a cross-coupler configured to redirect the light from the input coupler towards the output coupler.

12. An electronic device comprising:
a waveguide configured to propagate light; and
an optical coupler configured to redirect and replicate the light, wherein the optical coupler includes
a substrate on the waveguide, and
a diffractive grating in the substrate, wherein the diffractive grating is configured to impart a phase to the light upon diffracting the light and wherein the phase varies continuously as a function of position along an axis.

13. The electronic device of claim 12, wherein the function is a continuous and differentiable function.

14. The electronic device of claim 13, wherein the continuous and differentiable function is a sinusoidal function.

15. The electronic device of claim 13, wherein the continuous and differentiable function is a parabolic function.

16. The electronic device of claim 12, wherein the continuous and differentiable function is a linear function.

17. The electronic device of claim 12, wherein the phase varies continuously as a function of position along an additional axis orthogonal to the axis.

18. The electronic device of claim 17, wherein the phase varies parabolically along the axis and varies parabolically along the additional axis.

19. The electronic device of claim 12, wherein the diffractive grating comprises a surface relief grating.

20. An electronic device comprising:
a waveguide configured to propagate light; and
an optical coupler configured to redirect and replicate the light, wherein the optical coupler includes
a substrate on the waveguide, and
a surface relief grating (SRG) in the substrate, wherein the SRG has ridges and troughs that follow sinusoidal paths.
